(19) United States
(12) Patent Application Publication
(10) Pub. No.: US 2020/0049454 A1
(43) Pub. Date: Feb. 13, 2020

(54) Lateral Flashlight Lever Clamp

(71) Applicant: Alex Rockwell Leutzinger, Sparks, NV (US)

(72) Inventor: Alex Rockwell Leutzinger, Sparks, NV (US)

(21) Appl. No.: 16/100,140

(22) Filed: Aug. 9, 2018

(51) Int. Cl. F41G 1/35; F21V 21/088

(52) U.S. Cl. CPC F41G 1/35; F21V 21/0885

(57) ABSTRACT

An apparatus that attaches to a long-gun-mounted flashlight and augments the flashlight with a secondary mechanical means of activation, so that the user can activate the flashlight in a more ergonomic, less awkward motion, with their support hand. The inventive apparatus includes a two-piece, clam-shell clamp which attaches the apparatus to the tailcap of a long-gun-mounted flashlight. A lever/paddle is attached to the two-piece clamp by way of a pivot pin, which affords the lever/paddle a swinging motion, and allows a protrusion on the underside of the paddle/lever to make slight contact with the host flashlight's tailcap activation button. When the paddle/lever is depressed, the pivot mechanism converts lateral activation pressure on the paddle/lever to forward activation pressure on the host flashlight's button, wherein activating the flashlight.

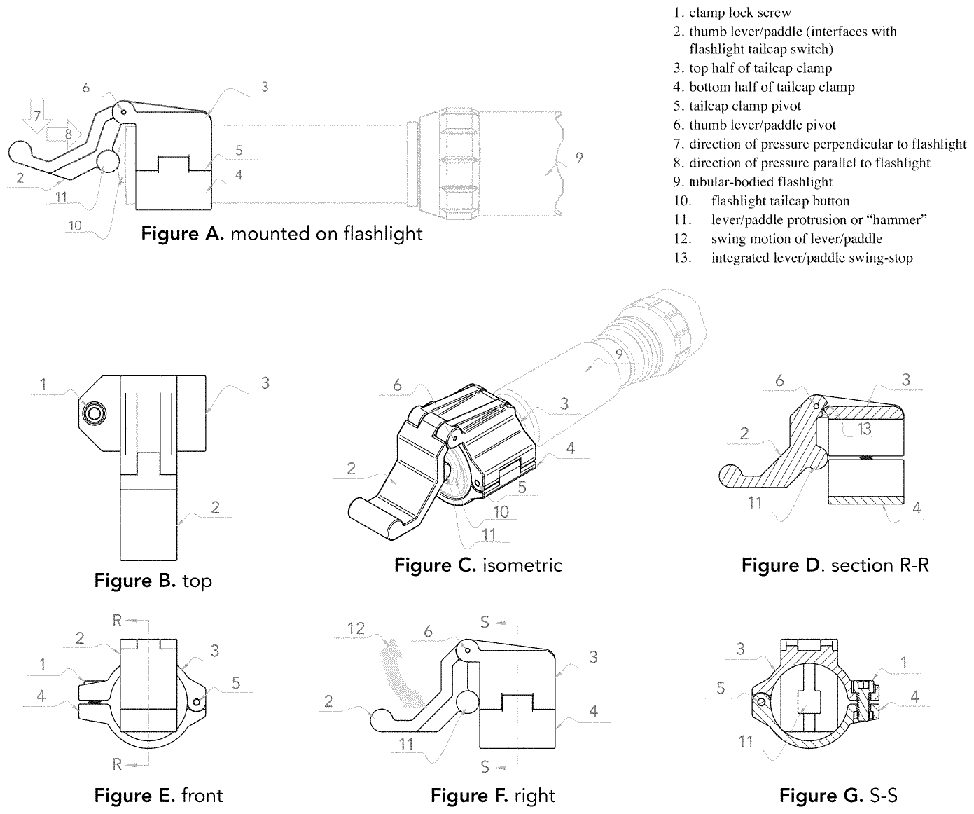

### CROSS REFERENCES TO RELATED APPLICATIONS

The present application claims the benefit of Provisional Patent Application Ser. No 62/576,088, filed Oct. 24, 2017, which is incorporated herein by reference in its entirety.

### BACKGROUND OF THE INVENTION

Flashlights are commonly mounted on military and law enforcement weapons to aid in accurate target identification during low-light conditions by prodding the ability to accurately identify and target subjects before engaging them. Because low-light target identification is critical for the safety of police, military, and the community, a weapon-mounted light needs to be easily located and activated.

Tube body flashlights are commonly mounted on weapons to provide illumination and are mounted parallel to the barrel of the weapon. Long-gun-mounted, tube-body flashlights are commonly activated by pushing a tail cap button, located on the end of the flashlight's body. The factory placement of the activation button on the end of the flashlight's tailcap, however, is non-ergonomic, or awkward to activate when mounted to a long-gun, because the means of activation requires forward motion of the user's thumb, of which, the same hand is grasping the weapon.

A common solution which makes activation of a tube-body weapon-mounted flashlight more natural and ergonomic, is to replace the flashlight's original button tailcap with a remotely wired switch that is still attached to, and still activates the flashlight, but is positioned remotely to a more ergonomic location on the long-gun, while being attached to the flashlight, with an electronic or electric wire. The relocation of the flashlight's activation switch allows the flashlight to be activated by a more ergonomic lateral squeeze motion.

There are three problems, however, with the common practice of replacing a flashlight's original button tailcap with a remotely wired switch:

Problem 1: The wires connecting the remotely activation switch to the flashlight, can become damaged from being melted, kinked, smashed, snagged, broken or any other means that electronic or electric wires are subject to fail.

Problem 2: If the remotely wired activation switch is damaged, there is not a redundant, secondary method to activate the light, as the original button has been replaced and is now gone.

Problem 3: Some remotely wired tape switches, when installed in place of a flashlight's original tailcap, do not perform all of the functionality that was originally available by way of using the factory-supplied button tailcap.

Accordingly, there is a need for a reliable, non-electronic/electric, mechanical way to activate a tube-body, weapon-mounted flashlight, which offers a less-awkward, more ergonomic actuation method.

### SUMMARY OF INVENTION

The subject invention is a mechanical lever that clamps onto the tail cap of a tube-body flashlight and activates the flashlight's tail cap button by squeezing or pressing a lever in an ergonomic direction perpendicular to the body of the flashlight.

### BRIEF DESCRIPTION OF THE DRAWINGS

The invention being depicted in the following drawings is a ‘lateral flashlight lever clamp’

FIG. A. is a right-side view of a tube-body flashlight with a ‘lateral flashlight lever clamp’ attached to the flashlight's tailcap

FIG. B. is a top view of a ‘lateral flashlight lever clamp’

FIG. C. is an isometric view of a ‘lateral flashlight lever clamp’ attached to a flashlight

FIG. D. is a cross-section view of FIG. E.

FIG. E. is a front view of a ‘lateral flashlight lever clamp’

FIG. F. is a right-side view of a ‘lateral flashlight lever clamp’

FIG. G. is a cross-section view of FIG. F.

### DETAILED DESCRIPTION OF PREFERRED EMBODIMENTS

For the purposes of the descriptions in this patent, a ‘lateral flashlight lever clamp’ will be referred to as “the invention”.

For the purposes of the descriptions in this patent, a “flashlight” is defined as a tubular bodied flashlight with an activation button residing in a tailcap at the opposite end of the illuminating lamp or bulb.

For the purposes of the descriptions in this patent, it is assumed that a flashlight is attached parallel to the barrel of a long-gun, rifle, or shotgun.

The invention (no. 1-9 of FIG. A-F) was designed to offer police and military personnel a more ergonomic, less awkward way to activate a long-gun-mounted flashlight when illuminating and identifying targets in low-light engagements.

Commonly long-gun-mounted flashlights have a push-button in the tailcap that is activated by the thumb of the support hand holding the long-gun, which is non-ergonomic and awkward. This invention allows the long-gun mounted flashlight to be activated with a lateral squeeze motion, leaving the user's support hand in an ergonomic, comfortable position.

In FIG. A there is depicted the invention (no. 2-8) clamped to a tailcap of a flashlight. The invention is designed to augment a flashlight with the ability to actuate the flashlight's tailcap button (no. 10) by pressing a clamped-on paddle (no. 2) laterally towards the long-gun (direction depicted in no. 7).

The user can mechanically activate the flashlight (no. 9 of FIG. A) by way of an attached lever (no. 2 of FIGS. A-F) that alters the normally required parallel motion pressure (no. 8 of FIG. A) to a less awkward, ergonomic, perpendicular motion pressure (no. 7 of FIG. A) required to activate the flashlight.

FIGS. A-F depict a ‘lateral flashlight lever clamp’ which is comprised of a hinged clamp or other mechanical feature (no. 1,3,4,5) that attaches the invention to the tailcap of a tube-body flashlight (no. 9). A hinge or other mechanical feature (no. 6) creates a fulcrum or other physical means to actuate a paddle, lever, or other mechanical feature (no. 2), which interfaces with and activates the tailcap button (no. 10) of a tube-body flashlight (no. 9).

The clamp is a clamshell style upper half (no. 3) and lower half (no. 4) that pivots on a pin (no. 5) affording a clamp force around the tailcap of the flashlight (no. 9) and locking the clamp in place with a lock screw (no. 1).

A paddle (no. 2) is attached to the clamp (no. 1,3,4,5) with a pin (no. 6). The pin (no. 6) also affords the paddle it's sweeping motion (path of motion depicted in no. 12). As the paddle (no. 2) travels in its sweeping motion (path of motion depicted in no. 12) a protrusion on the paddle interfaces with and actuates the flashlight's tailcap button (no. 10).

The paddle's (no. 2) interface (no. 11) with the flashlight's tailcap (no. 10), allows the user to access all of the functionality inherent to the attached flashlight (no. 9), including intensity, strobe, and momentary features.

If the paddle (no. 2) or the clamping mechanism (no. 1,3,4,5) breaks during use, there is still access to the flashlight's (no. 9) original tailcap button (no. 10) so that the user still has a secondary, redundant means to operate the flashlight in a possible life-threatening situation.

### DETAILED DESCRIPTION OF THE INVENTION

The objective of this invention is to afford the user, a more ergonomic, secondary method of activating a long-gun-mounted, tube-body flashlight. By way of an attached mechanical device, the flashlight's inherent method of tailcap button activation, is augmented with a secondary method of activation, specifically, a lateral lever press. In order to achieve the secondary, lateral press method of activation, the apparatus utilizes a pivoting lever that is clamped to the flashlight's tailcap. When the lever is depressed, a protuberance on the underside of the lever, exerts pressure against the flashlight's tailcap button, activating the flashlight.

The subject invention offers a less awkward, more comfortable means to activate a long-gun-mounted flashlight. It it also affords the user a built-in redundancy factor, specifically, if the subject invention ever fails, the primary tailcap button can still be accessed to activate the light.

Tactical tube-body flashlights often have multiple intensity levels, strobe modes, as well as momentary and “stay-on” capabilities. When the subject invention is installed and used on a flashlight, all of the inherent capabilities of the original flashlight, including momentary, intensity, and strobe features are preserved since the subject invention augments the flashlight's tailcap button, rather than replace it.

(flashlight defined in this description as a tubular bodied flashlight with an activation button residing in a tailcap at the opposite end of the light-emitting lamp, bulb or diode).

What is claimed is:

1. A mechanical apparatus that attaches to a tubular-bodied, long-gun-mounted flashlight which affords a user, the ability to activate the flashlight's tailcap button by pressing a lever or paddle with said user's support hand, whereby utilizing a system of leverage that converts the direction of mechanical actuation required to press the flashlight's tailcap button, from forward pressure that is parallel to the flashlights body, to lateral pressure that is perpendicular to the flashlight's body, such that the flashlight's inherent method of activation is augmented with a secondary method of activation.

2. The mechanical system of claim 1, wherein a clamping system attaches the apparatus to a tubular-bodied flashlight that is mounted to a long-gun.

3. The mechanical system of claim 1, wherein a pivoting lever or paddle is attached to, and pivots on, the clamping system, such that contact from the paddle or lever, to the flashlight's tailcap button can be made.

4. The mechanical system of claim 1, wherein a pivoting lever or paddle makes contact with the existing tailcap button of a tubular-bodied flashlight and actuates said tailcap button, such that all of the inherent modes of the flashlight can be activated.

5. The mechanical system of claim 1, wherein the actuation paddle or lever sits parallel to the body of the flashlight plus or minus 30 degrees

6. The mechanical system of claim 4, wherein the flashlight's tailcap button can be activated by the paddle or lever with a pressure force similar to that required to activate the flashlight's inherent mode of actuation.

7. The mechanical system of claim 4, a shelf or surface is integrated into the paddle/lever which interfaces with a corresponding shelf or flat surface on the attachment mechanism, that creates a stoppage which impedes the motion of the paddle/lever in either of its two inherent directions of movement.

8. The mechanical system of claim 3 wherein the pivoting lever or paddle comprises a first portion that is attached to a pivot and, in use, extends adjacent the tailcap button of the flashlight, and a second portion that extends outward of the first portion and provides a surface that, in use, can receive lateral pressure to pivot the pivoting lever.

9. The mechanical system of claim 8 wherein the pivot is disposed, in use, to a lateral side of the tailcap button.
